(19) United States
(12) Patent Application Publication
(10) Pub. No.: US 2017/0063291 A1
(43) Pub. Date: Mar. 2, 2017

(54) FIXED TYPE SOLAR GENERATOR EQUIPPED WITH REFLECTOR

(71) Applicant: SUNG CHANG TELECOM CO., LTD., Cheongju-si (KR)

(72) Inventor: Jai-Jin LEE, Cheongju-si (KR)

(21) Appl. No.: 14/843,126

(22) Filed: Sep. 2, 2015

(51) Int. Cl. H02S 20/32; F24J 2/38; H02S 20/24; F24J 2/40

(52) U.S. Cl. CPC H02S 20/32; F24J 2/407; F24J 2/38; H02S 20/24

(57) ABSTRACT

A fixed-type solar generator with minimally controlled reflector includes: solar collector panel facing culmination of sun, first and second reflectors rotatably provided on east and west sides of the solar collector panel, respectively, sensor module and control module. The sensor module includes a first sensor for detecting greater light amount from sun while in a first section from sunrise to culmination than while in a second section from culmination to sunset, and a second sensor for detecting greater light amount from the sun while in the second section from culmination to sunset than while in the first section from sunrise to culmination. The control module controls a rotation angle of at least one of the first and second reflectors based on a first light intensity value detected by first sensor and a second light intensity value detected by second sensor.

### TECHNICAL FIELD

The present disclosure in some embodiments relates to a fixed type solar generator, and more particularly, relates to a fixed type solar generator equipped with a minimally controlled (perpendicularly controlled or uncontrolled) reflector using least control parameters for increasing the power generation amount.

### BACKGROUND

The statements in this section merely provide background information related to the present disclosure and may not constitute prior art.

Generally, a solar generator is constituted by solar cells, a storage battery and a power converter, and serves as a power generation facility which has a plurality of the solar cells installed to form a solar collector panel for collecting the light of the sun and converting the light energy into electrical energy.

The solar generator provides generation capacities that differ by the number of solar cells installed as appropriate to the required power supply for the site in need, implementing a small-scale power generation for household needs as well as a large-scale power generation for industrial application.

Depending on the installation method of the solar collector panel, photovoltaic or solar generators may be classified into a fixed type and a solar tracking type.

The fixed solar generator has its solar collector panel fixed at an angle that can receive the most possible amount of sunlight, having a merit of a simple structure to facilitate installation and maintenance thereof with disadvantageously drastic deviations of power generation amount by varying incident angles of sunlight to exhibit a poor average power generation efficiency.

Solar tracking photovoltaic generators are classified into a single-axis rotation type for rotating the solar collector panel so as to track the movement of the sun from the east at sunrise to the west at sunset, and a dual-axial rotation type for rotating the solar collector panel so as to further track the varying altitudes of meridian passage of the sun or culmination altitude. The single-axis rotation generator has a simpler structure of driving unit with a lower power generation efficiency relative to the dual-axis rotation generator. The dual-axis rotation generator, in comparison, may maintain a constant perpendicularity between the incident direction of sunlight and the solar cell module to seek the maximum possible power generation efficiency.

However, the solar tracking generators entail emerging issues of frequently failed trackers as indicated by members of the solar industry, who have conventionally employed cheap flimsy offshore components. Users of the conventional tracker generators have been frequently troubled by inoperable trackers due to power issues or dysfunctional trackers with inherently deficient durability overwhelmed by an externally derived impact.

Therefore, currently, the fixed system is adopted for electric generation by more than 95% of the Inventor's domestic solar power generation market despite of the recognized high efficiency with the tracking system because of the deficiencies described above.

In other words, the frequent malfunctions and failures occurred have negated the high power generation efficiency of the solar tracker to divert the majority potential solar power plant customers to adopt the fixed solar power system, which leaves an unmet need for providing a measure to boost the power generation amount for the fixed solar power plants.

The inventors have come to know a prior art of Korean Patent Registration No. 10-1359438 issued Jan. 29, 2014 to GTC CORPORATION CO., LTD., and entitled ‘a roof fixing type solar generator’ as patent document 1 wherein a fixed inclined roof type solar generation device is provided to effectively support a solar panel with a roof fixing frame and to control the inclination angle for installation on an inclined surface of a roof. A fixed inclined roof type sunlight generation device comprises a roof fixture, a first vertical rod, a second vertical rod, a first horizontal rod, a second horizontal rod, an inclined fixing rod, a solar panel fixture, and a solar panel. A plurality of the roof fixtures is fixed on the upper surface of an inclined roof in an inclined direction, and the first vertical rod and the second vertical rod are fixed to each roof fixture. The horizontal rod is installed by connecting the upper end of a plurality of the vertical rods, and a pair of the inclined fixing rods is installed on the horizontal frame. The solar panel fixture is fixed by passing through the inclined fixing rod, and the solar panel is fixed to the solar panel fixture.

### SUMMARY

In accordance with some embodiments, the present disclosure provides a fixed-type solar generator with a minimally controlled reflector, including a solar collector panel, first and second reflectors, a sensor module and a control module. The solar collector panel is installed to face culmination of the sun. The first and second reflectors are rotatably provided on an east side and a west side of the solar collector panel, respectively. The sensor module includes a first sensor configured to detect a greater amount of light from the sun while in a first section from sunrise to culmination than while in a second section from the culmination to sunset, and a second sensor configured to detect a greater amount of light from the sun while in the second section from the culmination to the sunset than while in the first section from the sunrise to the culmination. The control module controls a rotation angle of at least one of the first reflector and the second reflector based on a first light intensity value detected by the first sensor and a second light intensity value detected by the second sensor.

The control module may be configured to control rotation angles of the first reflector and the second reflector into about 180 degrees and about 90 degrees, respectively if the first light intensity value is equal to or more than a preset first reference value and if the second light intensity value is equal to or less than the first reference value, to control the rotation angles of the first reflector and the second reflector into about 90 degrees and about 180 degrees, respectively if the second light intensity value is equal to or more than the first reference value and if the first light intensity value is equal to or less than the first reference value, and to control the rotation angles of the first reflector and the second reflector commonly into about 180 degrees if the first and second light intensity values are both equal to or more than the first reference value.

The control module may be configured to control the rotation angles of the first reflector and the second reflector commonly into about 180 degrees if the first and second light intensity values are both equal to or less than a preset second reference value.

The first sensor may be arranged obliquely to have a first light-receiving surface facing the position of the sun while in the sunrise to the culmination, and the second sensor may be arranged obliquely to have a second light-receiving surface facing the position of the sun while in the culmination to the sunset.

### BRIEF DESCRIPTION OF DRAWINGS

FIG. 1 is a diagram of a configuration of a fixed type solar generator equipped with a minimally controlled reflector, according to some embodiments of the present disclosure.

FIG. 2 is an exemplary diagram of a configuration of a sensor module of FIG. 1.

FIG. 3 is an exemplary graph diagram of the sensitivities of the first and second sensors by the position of the sun over time.

FIG. 4 is an exemplary diagram of the path of the sun from sunrise to sunset.

FIGS. 5, 6, 7 and 8 are exemplary diagrams of controls of the rotation angles of reflectors, according to some embodiments of the present disclosure.

FIG. 9 is views of an example of installing the fixed type solar generator equipped with a minimally controlled reflector, according to some embodiments of the present disclosure.

DESCRIPTION OF REFERENCE NUMERALS

| | |
|---|---|
| 10: solar collector panel | 10a: light-receiving surface |
| 21: first reflector | 21a: reflective surface |
| 22: second reflector | 22a: reflective surface |
| 30: control module | 40: sensor module |
| 41: first sensor | 42: second sensor |
| 45: surface | 45a: first surface section |
| 45b: second surface section | 47, 47A, 47b: vertical plane |

### DETAILED DESCRIPTION

The present disclosure seeks to provide a fixed-type solar generator which is installed easily at a low cost and equipped with a minimally controlled reflector for maximizing the power generation efficiency.

Hereinafter, at least one embodiment of the present disclosure will be described in detail with reference to the accompanying drawings. In the following description, like reference numerals designate like elements, although the elements are shown in different drawings. Further, in the following description of the at least one embodiment, a detailed description of known functions and configurations incorporated herein will be omitted for the purpose of clarity and for brevity.

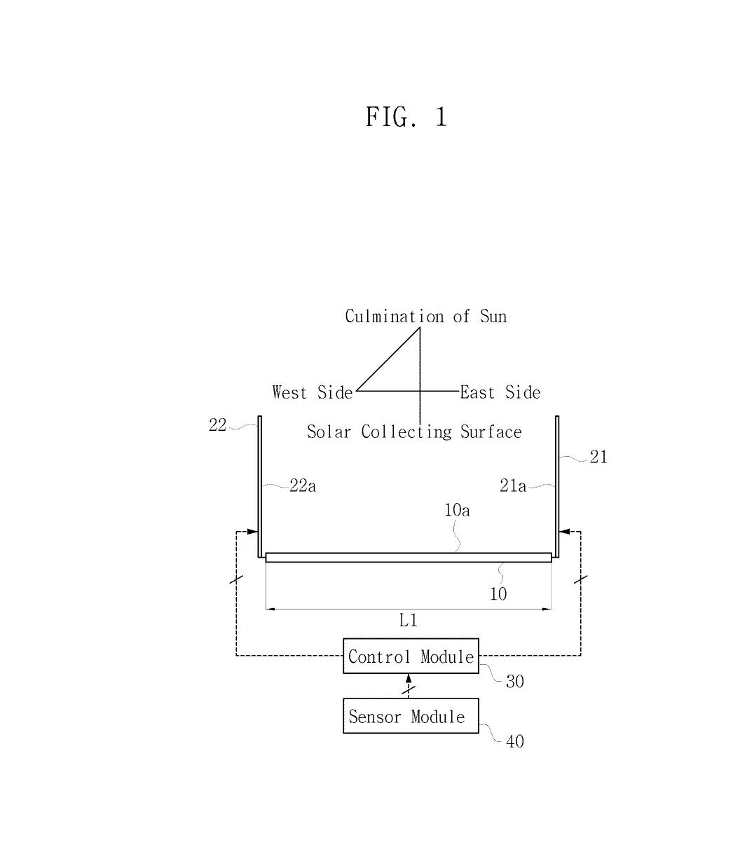

FIG. 1 is a diagram of a configuration of a fixed type solar generator equipped with a minimally controlled reflector, according to some embodiments of the present disclosure. As illustrated, the solar generator may include a solar collector panel 10, reflectors 21 and 22, a control module 30, and a sensor module 40.

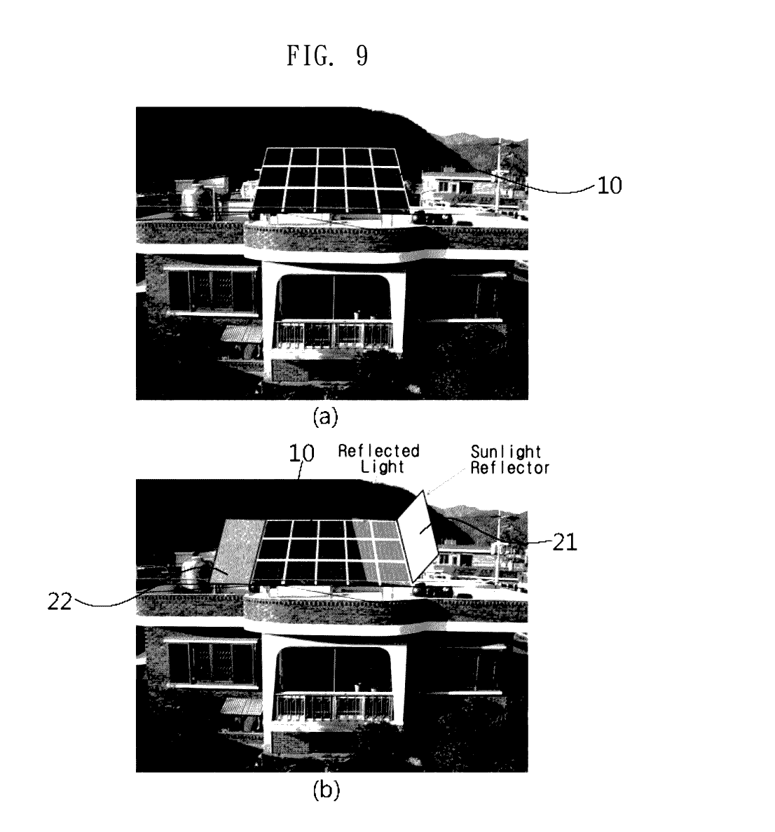

The collector panel 10 is adapted to be installed for collecting sunlight by having its light-receiving surface 10a face the culmination of the sun (or solar azimuth angle at culmination hour), similar to a collector panel of a conventional fixed-type solar generator as shown in (a) in FIG. 9, and detailed description thereof will be omitted.

The reflectors 21 and 22 are intended to reflect sunlight radiating out of the area of the solar collector panel 10 for causing the loose radiation to be incident on the relevant light-receiving surface 10a. The reflectors may include, for example, a first reflector 21 mounted rotatably on the east side of the solar collector panel 10 and a second reflector 22 mounted rotatably on the west side of the solar collector panel 10.

According to at least one embodiment, the reflectors 21, 22 are made of a high-strength, lightweight material and adopt a minimal control scheme to move at a predetermined angle. Rather than reinforced glass, silicon and a thin film material that make up a solar photovoltaic module which is then vulnerable to motor vibration and wind damage, the reflectors 21, 22 may be configured by using a high-strength, lightweight material such as glass, aluminum, ultra-thin and high-strength stainless steel. Accordingly, the reflectors 21, 22 may be freely deformed in structure by punching, ablation, air-hole boring, etc. The lightened material of the reflectors leads to lightweight and low-power-consumption actuators and motors as the rotating arrangement therefor, and thereby minimize the power consumption relative to the increase of the power generation.

In at least one embodiment, the reflectors 21, 22 are each capable of rotating about its side connected to the solar collector panel 10 so that a reflective surface 21a or 22a of each of the reflectors 21, 22 establish rotation angles within about 180 degrees with respect to the light-receiving surface 10a of the solar collector panel 10. The mechanical structure for rotating the reflectors 21, 22 may be variably designed according to the conventional method, and hence a description thereof will be omitted.

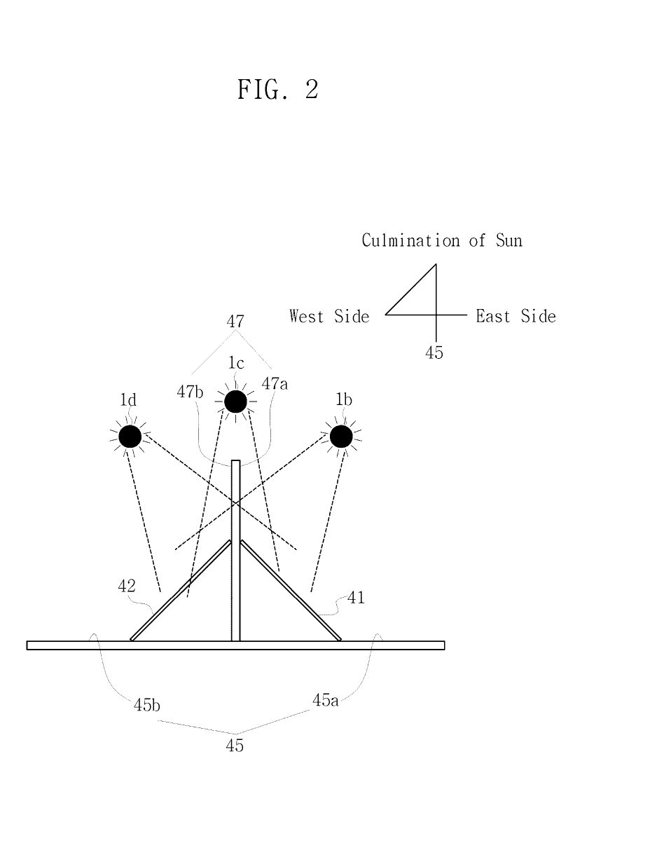

The sensor module 40 is provided for detecting the intensity of the light corresponding to the position of the sun (or referred to as an amount of light). For example, the sensor module 40 includes a first sensor 41 for detecting a greater amount of light from the sun while in a first section from sunrise to culmination than while in a second section from the culmination to sunset, and a second sensor 42 for detecting a greater amount of light from the sun while in the second section from the culmination to the sunset than while in the first section from the sunrise to the culmination. An example of a specific structure the sensor module 40 will be described with reference to FIG. 2.

As shown in FIG. 2, the sensor module 40 is assumed to be a sensory structure that includes a surface 45 and a vertical plane 47a, 47b: 47 extending upright from the center of the surface 45 so as to divide the surface 45 into a first surface section 45a and a second surface section 45b. Then, the first sensor 41 may be obliquely mounted at a predetermined angle to connect between the first surface section 45a and the vertical plane 47a, and the second sensor 42 may be obliquely mounted at the predetermined angle to connect between the second surface section 45b and the vertical plane 47b. Thus, the first sensor 41 may be arranged obliquely to have its light-receiving surface face the position of the sun while in the sunrise to the culmination, and the second sensor 42 may be arranged obliquely to have its light-receiving surface face the position of the sun while in the culmination to the sunset.

Referring back to FIG. 1, the control module 30 is for controlling the rotational operations of the first and second reflectors 21, 22 so as to control the angles of rotation or rotation angles between the reflective surfaces 21a, 22a of the reflectors and the light-receiving surface 10a of the solar collector panel 10. For example, the control module 30 may perform a comparison of a first light intensity value detected by the first sensor 41 with a second light intensity value detected by the second sensor 42, and control the rotation angle of at least one of the first and second reflectors 21, 22 based on the comparison.

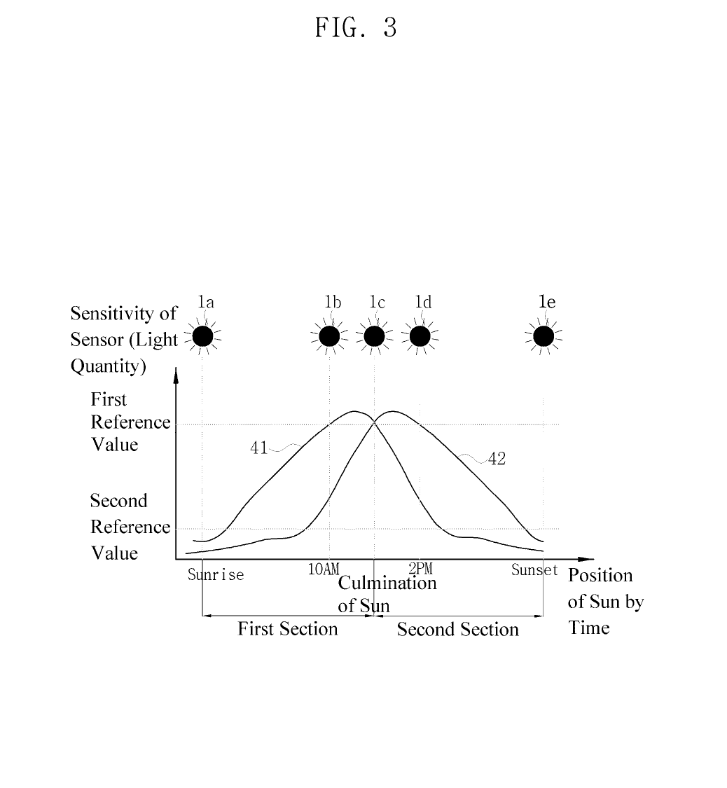

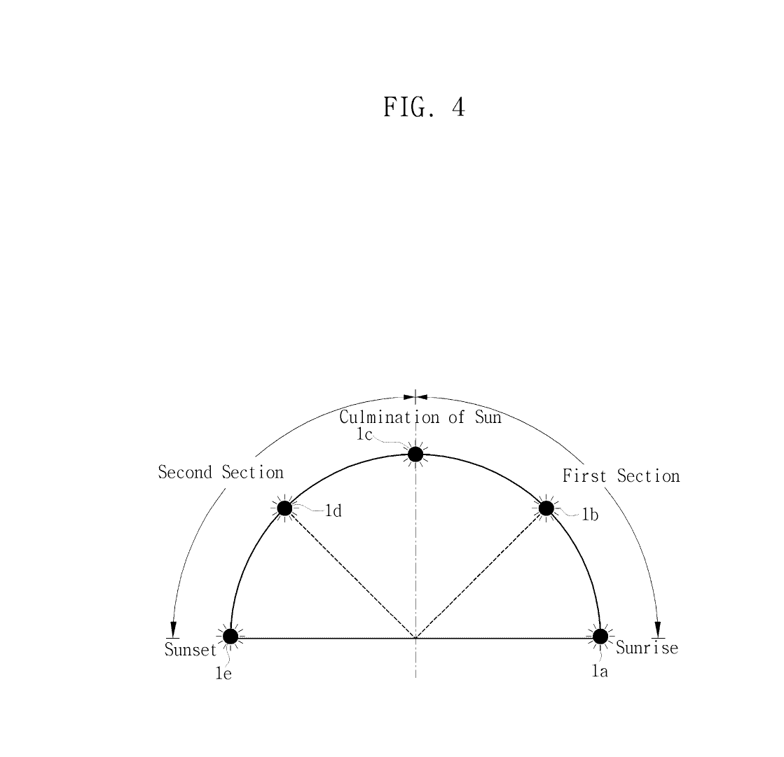

FIG. 3 is an exemplary graph diagram of the sensitivities of the first and second sensors 41, 42 by the position of the sun over time, in the sensor module 40 of a fixed type solar generator equipped with a minimally controlled reflector, according to some embodiments of the present disclosure. FIG. 4 is an exemplary diagram of the path of the sun from sunrise to sunset.

According to at least one embodiment, as shown in FIGS. 3 and 4, a comparison between the sensitivities (or light intensity values) of the first and second sensors 41, 42 by the position of the sun over time exhibits a greater first light intensity value obtained by the first sensor 41 from the sun while in a first section over a span of sunrise to culmination than that obtained by the sensor 42, and a greater second light intensity value obtained by the second sensor 42 from the sun while in a second section over a span of the culmination to the sunset than that obtained by the first sensor 41.

Moreover, according to some embodiments, only the first light intensity value detected by the first sensor 41 equal to or greater than a preset first reference value in a part (e.g., around 10 AM to culmination) of the first sunrise-culmination section, and the first reference value is equaled or exceeded only by the second light intensity value detected by the second sensor 42 in a part (e.g., culmination to around 2 PM) of the second culmination-sunset section.

In addition, according to some embodiments, when the sun is positioned at the culmination and its vicinity, the two light intensity values detected by the first and second sensors 41, 42 are both equal to or greater than the first reference value. Around sunrise or sunset, the two light intensity values detected by the first and second sensors 41, 42 are both equal to or less than a preset second reference value.

The control module 30 may control rotation angles of the first reflector 21 and the second reflector 22 into about 180 degrees and about 90 degrees, respectively if the first light intensity value from the first sensor 41 is equal to or more than the preset first reference value and if the second light intensity value from the second sensor 42 is equal to or less than the first reference value.

In contrast, the control module 30 may control the rotation angles of the first reflector 21 and the second reflector 22 into about 90 degrees and about 180 degrees, respectively if the second light intensity value from the second sensor 42 is equal to or more than the first reference value and if the first light intensity value from the first sensor 41 is equal to or less than the first reference value.

Further, the control module 30 may control the rotation angles of the first reflector 21 and the second reflector 22 commonly into about 180 degrees if the two light intensity values from the first and second sensors 41, 42 are both equal to or less than the preset second reference value.

Further, the control module 30 may control the rotation angles of the first reflector 21 and the second reflector 22 commonly into about 180 degrees if the two light intensity values from the first and second sensors 41, 42 are both equal to or less than the preset second reference value.

In some embodiments, the first reference value and second reference value respectively represent an upper limit reference value and a lower limit reference value which may be set empirically. For example, the first reference value may be set to about 5000 Lux, and the second reference value to about 1000 Lux.

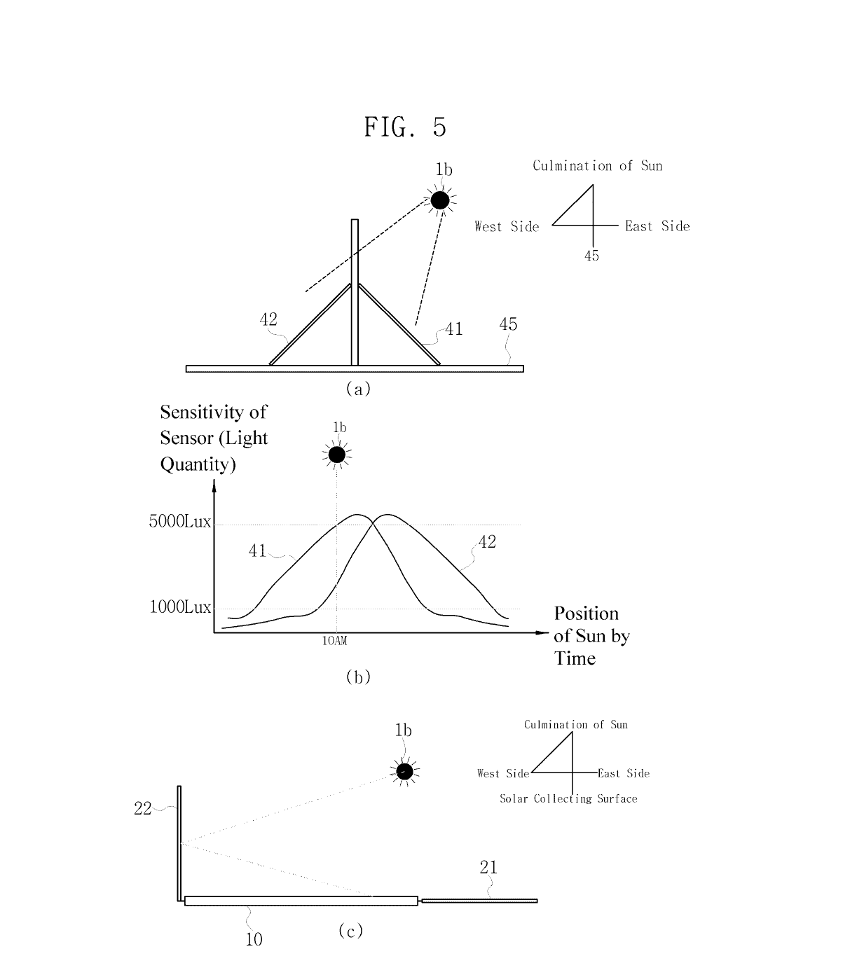

FIGS. 5, 6, 7 and 8 are various exemplary diagrams of controls of the rotation angles of reflectors, according to some embodiments of the present disclosure.

Referring to FIG. 5, when the sun is positioned at 1b at around 10 AM in the first section over the span of sunrise to culmination, the sensor module 40 detects the first light intensity value equal to or greater than the preset first reference value of 5000 Lux exclusively by its first sensor 41 and detects the second light intensity value equal to or less than the first reference value exclusively by its second sensor 42, as shown in (a) and (b) in FIG. 5. Based on the detections, the control module 30 may control the rotation angles of the first reflector 21 and the second reflector 22 into about 180 degrees or about 90 degrees, as shown in (c) in FIG. 5.

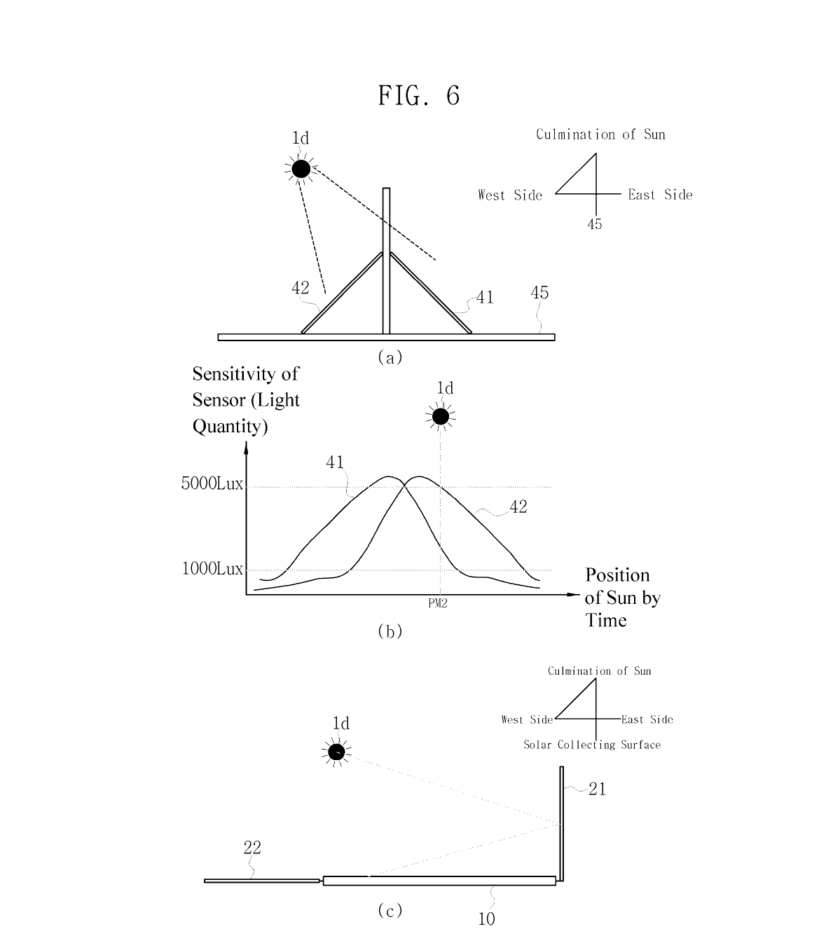

Turning to FIG. 6, when the sun is positioned at 1d at around 2 PM in the second section over the span of culmination to sunset, the sensor module 40 detects the first light intensity value equal to or greater than the preset first reference value of 5000 Lux exclusively by its second sensor 42 and detects the second light intensity value equal to or less than the first reference value exclusively by its first sensor 41, as shown in (a) and (b) in FIG. 6. Accordingly, the control module 30 may control the rotation angles of the first reflector 21 and the second reflector 22 into about 90 degrees or about 180 degrees, as shown in (c) in FIG. 6.

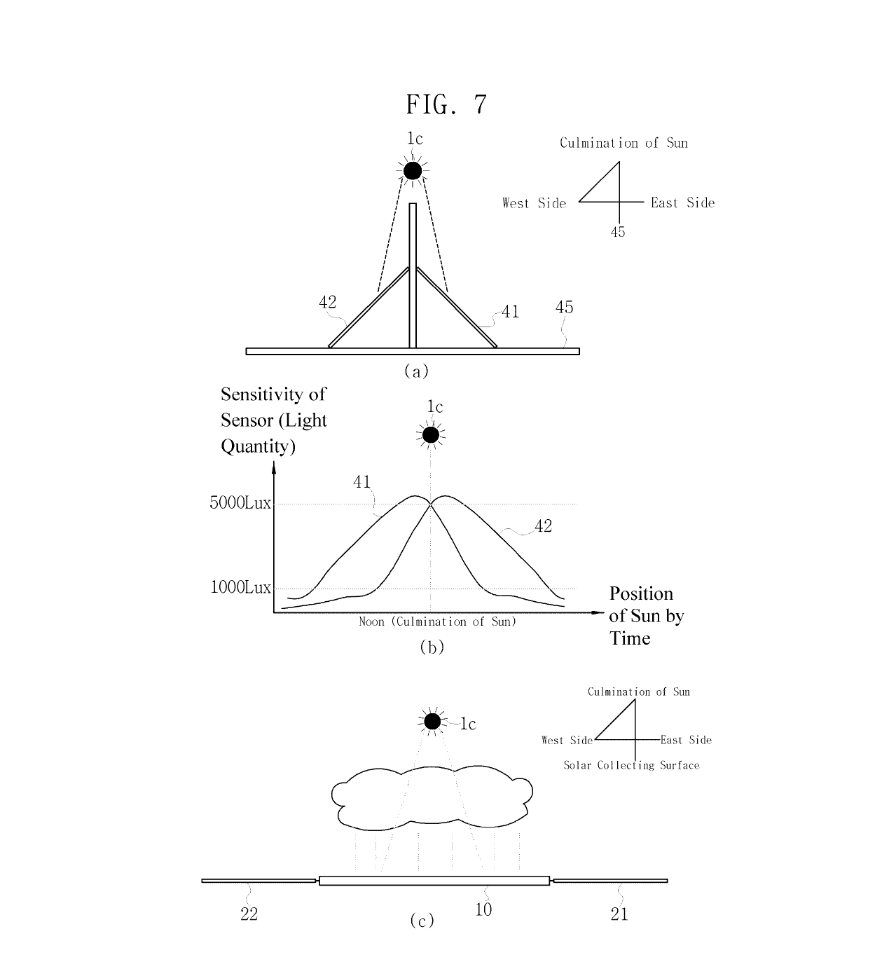

Referring to FIG. 7, when the sun culminates at 1c culminates, the sensor module 40 detects a light intensity value equal to or greater than the preset first reference value of 5000 Lux by both of the first and second sensors 41, 42, as shown in (a) and (b) in FIG. 7. Based on the detections, the control module 30 may control the rotation angles of the first reflector 21 and the second reflector 22 commonly into about 180 degrees, to enable the solar collector panel 10 to absorb both the strong direct light and the scattered light, as shown in (c) in FIG. 7.

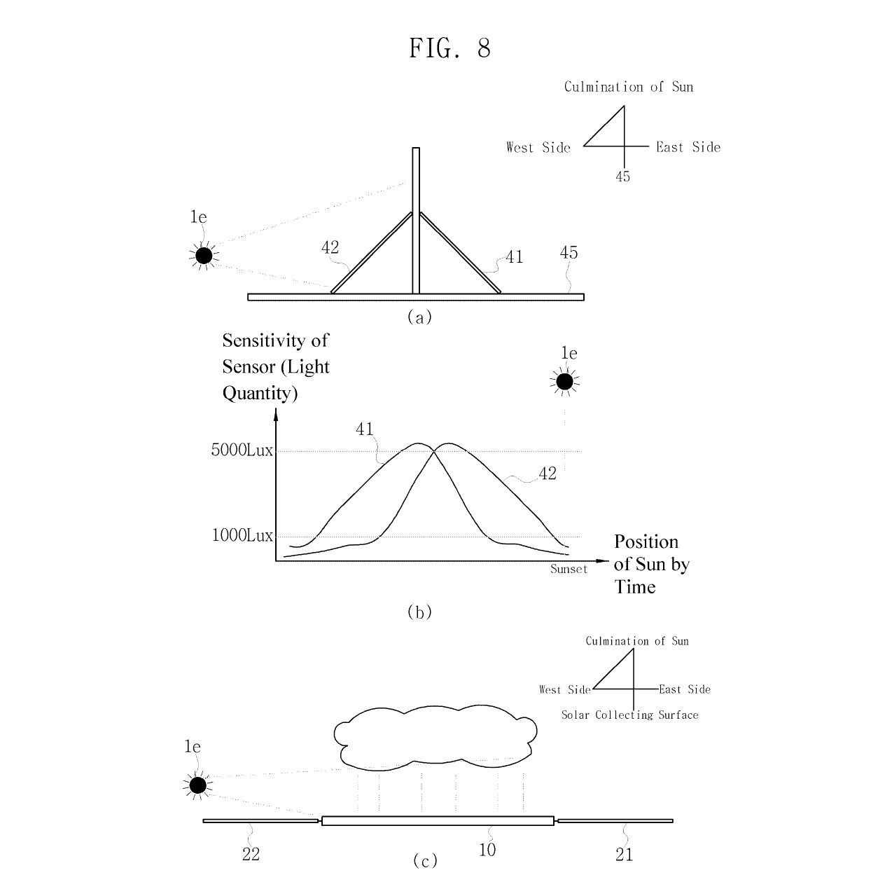

Referring to FIG. 8, when the sun is positioned at 1e at around sunset or sunrise or in a cloudy day, the sensor module 40 detects a light intensity value equal to or less than the preset second reference value of 1000 Lux by both of the first and second sensors 41, 42, as shown in (a) and (b) in FIG. 8. Based on the detections, the control module 30 may control the rotation angles of the first reflector 21 and the second reflector 22 commonly into about 180 degrees, to enable the solar collector panel 10 to absorb most of the scattered light, as shown in (c) in FIG. 8.

FIG. 9 is views of an example process of installing the fixed type solar generator of FIG. 1. According to some embodiments, a conventional fixed-type solar generator may be first provided as in (a) in FIG. 9, and the first reflector 21 and the second reflector 22 may be installed as an easy retrofit to the opposite sides of the fixed-type solar generator, whereby facilitating improvement of existing solar installation and significantly reducing installation costs.

As explained above, the power generation amount for fixed-type solar power plants can be increased, saving entirely new productions of redesigned solar generator or dismantlement of existing facilities with retrofitting according to various aspects of the present disclosure, which can significantly reduce the installation cost of improving the existing facilities.

In addition, the reflectors can be controlled by a minimal control scheme (perpendicularly controlly or uncontrolled) with comparisons performed by two super lightweight light sensors, to minimize the malfunction of the control circuit and reduce the power consumption, simplify the sensor structure and the control circuit, giving the benefit of minimized failure and maximized service life with an effect of greatly improved and superior power generation efficiency of the fixed-type solar generator.

Although exemplary embodiments of the present disclosure have been described for illustrative purposes, those skilled in the art will appreciate that various modifications, additions and substitutions are possible, without departing from the various characteristics of the disclosure.

What is claimed is:

1. A fixed type solar generator equipped with a minimally controlled reflector, the fixed type solar generator comprising:
a solar collector panel installed so as to face culmination of the sun;
a first reflector and a second reflector rotatably provided on an east side and a west side of the solar collector panel, respectively;
a sensor module comprising:
a first sensor configured to detect a greater amount of light from the sun while in a first section from sunrise to the culmination than while in a second section from the culmination to sunset, and
a second sensor configured to detect a greater amount of light from the sun while in the second section from the culmination to the sunset than while in the first section from the sunrise to the culmination; and
a control module configured to perform a comparison of a first light intensity value detected by the first sensor with a second light intensity value detected by the second sensor, and to control a rotation angle of at least one of the first reflector and the second reflector into about 90 degrees or about 180 degrees based on the comparison,
wherein the rotation angle represents an angle between a reflective surface of the first reflector or the second reflector and a collecting surface of the solar collector panel.

2. The fixed type solar generator of claim 1, wherein the control module is configured to
control rotation angles of the first reflector and the second reflector into about 180 degrees and about 90 degrees, respectively if the first light intensity value is equal to or more than a preset first reference value and if the second light intensity value is equal to or less than the first reference value,
control the rotation angles of the first reflector and the second reflector into about 90 degrees and about 180 degrees, respectively if the second light intensity value is equal to or more than the first reference value and if the first light intensity value is equal to or less than the first reference value, and
control the rotation angles of the first reflector and the second reflector commonly into about 180 degrees if the first and second light intensity values are both equal to or more than the first reference value.

3. The fixed type solar generator of claim 2, wherein the control module is configured to
control the rotation angles of the first reflector and the second reflector commonly into about 180 degrees if the first and second light intensity values are both equal to or less than a preset second reference value.

4. The fixed type solar generator of claim 3, wherein the first reference value is an upper limit reference value and the second reference value is a lower limit reference value.

5. The fixed type solar generator of claim 1, wherein
the first sensor is arranged obliquely to have a first light-receiving surface facing the position of the sun while in the sunrise to the culmination, and
the second sensor is arranged obliquely to have a second light-receiving surface facing the position of the sun while in the culmination to the sunset.
